(19) United States
(12) Patent Application Publication
(10) Pub. No.: US 2018/0107773 A1
(43) Pub. Date: Apr. 19, 2018

(54) SIMULATION METHOD AND INFORMATION PROCESSING APPARATUS

(71) Applicant: FUJITSU LIMITED, Kawasaki-shi (JP)

(72) Inventors: Jun FUJISAKI, Kawasaki (JP); Koichi Shimizu, Inagi (JP)

(73) Assignee: FUJITSU LIMITED, Kawasaki-shi (JP)

(21) Appl. No.: 15/688,940

(22) Filed: Aug. 29, 2017

(30) Foreign Application Priority Data
Oct. 19, 2016 (JP) 2016-204891

(51) Int. Cl. G06F 17/50

(52) U.S. Cl. CPC G06F 17/5018; G06F 2217/16

(57) ABSTRACT

An information processing apparatus compares threshold values based on distance data indicating distances between a plurality of nodes in a first mesh model with coefficient values corresponding to a plurality of pairs of nodes in the first matrix data, and updates at least some of evaluation values corresponding to the nodes on the basis of a comparison result. The information processing apparatus generates second matrix data of a second mesh model created by excluding some of the nodes selected on the basis of the evaluation values from the first mesh model. Then, the information processing apparatus calculates a solution of a plurality of variables associated with the nodes, by using the first matrix data and the second matrix data.

### CROSS-REFERENCE TO RELATED APPLICATION

This application is based upon and claims the benefit of priority of the prior Japanese Patent Application No. 2016-204891, filed on Oct. 19, 2016, the entire contents of which are incorporated herein by reference.

### FIELD

The embodiments discussed herein relate to a simulation method and an information processing apparatus.

### BACKGROUND

In simulation, such as structural analysis, fluid analysis, and electromagnetic field analysis, an object region and a space region are divided into a plurality of elements to create a mesh model, and simultaneous equations are created from the mesh model and are solved. For example, variables are assigned to nodes positioned at the tips of the elements, and coefficient values derived from a physical law are assigned to all pairs of nodes. A variable at each node is calculated by solving the simultaneous equations defined by a coefficient matrix which is a collection of coefficient values. An iterative method, such as a conjugate gradient (CG) method, is used to solve the simultaneous equations, in some cases. In the iterative method, calculation of an approximate solution and evaluation of its error are repeated to reduce the error in a step-by-step manner and to get the approximate solution closer to a real value.

In the iterative method, an algebraic multigrid (AMG) method is used as a preconditioning procedure, in some cases. In the algebraic multigrid method, a coarse mesh model is generated by excluding some of nodes from an original fine mesh model. Then, a coefficient matrix corresponding to the coarse mesh model is used in combination with a coefficient matrix corresponding to the fine mesh model, in order to calculate an approximate solution. This utilizes characteristics of the error that rapidly attenuates its frequency component corresponding to an element size of a mesh model when iterative calculation is performed by using the mesh model. That is, it is difficult to attenuate a low-frequency component (long-wavelength component) of the error by using a fine mesh model only, but this error is attenuated rapidly by using a coarse mesh model.

There is proposed a mesh generation device that automatically generates a mesh model for use in structural analysis and magnetic field analysis, for example. The proposed mesh generation device divides an object region into a plurality of elements, and determines whether the aspect ratio of each divided element is within a predetermined allowable range. When there is a long and thin element whose aspect ratio is out of the allowable range, the mesh generation device divides the long and thin element by adding one or more nodes.

Moreover, there is proposed a magnetization distribution analysis method that simulates magnetization distribution of a magnetic device, for example. In the proposed magnetization distribution analysis method, a model of the magnetic device is divided into a plurality of elements, and coefficients are classified on the basis of relative positions between the elements and are stored in a memory. Then, of the coefficients classified on the basis of the relative positions, coefficients for use in calculation are read out from the memory as appropriate, in order to calculate a static equilibrium state of total magnetic energy of all the elements.

Furthermore, there is proposed a high-speed computation method for solving simultaneous equations generated by a finite element method and a boundary element method, for example. In the proposed high-speed computation method, a model is divided into a plurality of grid elements, and two edges that are not on a common plane and have a small distance from each other are extracted from among the edges of the elements on a boundary. Then, coefficient values corresponding to the extracted two edges are identified from among a coefficient matrix of simultaneous equations, and the identified coefficient values are sorted so as to be positioned in the vicinity of a diagonal line of the coefficient matrix.

See, for example, Japanese Laid-open Patent Publication No. 5-290015, Japanese Laid-open Patent Publication No. 10-325858, and International Publication Pamphlet No. WO 2008/026261.

By the way, a mesh model including a distorted element having a flat shape, a long and thin shape, a sharp shape having a node that is far from other nodes, or the like may be created, depending on a shape of a simulation target and a creation method of the mesh model. When iterative calculation using an algebraic multigrid method or the like is performed by using the mesh model including such a distorted element, calculation tends to converge slower than when the mesh model does not include the distorted element. As a result, problems, such as increase in the number of iterations, increase in calculation time, and decrease in accuracy of approximate solution, occur in some cases.

### SUMMARY

According to one aspect, there is provided a non-transitory computer-readable storage medium storing a computer program that causes a computer to perform a procedure including: acquiring first matrix data including coefficient values indicating attributes between a plurality of nodes in a first mesh model; generating distance data indicating distances between the plurality of nodes, based on position coordinates of the plurality of nodes in the first mesh model; calculating a threshold value based on a distance indicated by the distance data corresponding to each of a plurality of pairs of the nodes in the first mesh model; comparing the threshold value with a coefficient value corresponding to the each pair of the nodes in the first matrix data; updating at least some of a plurality of evaluation values respectively corresponding to the plurality of nodes, based on a result of the comparing; generating second matrix data of a second mesh model created by selecting some of the plurality of nodes, based on the plurality of evaluation values and excluding the selected some nodes from the first mesh model; and calculating a solution of a plurality of variables associated with the plurality of nodes, by using the first matrix data and the second matrix data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an information processing apparatus of a first embodiment;

FIG. 2 is a block diagram illustrating a hardware example of a simulation apparatus of a second embodiment;

FIG. 3 is a block diagram illustrating functional blocks representing functions of a simulation apparatus of the second embodiment;

FIG. 4 is a flowchart illustrating a matrix data generation process executed by a simulation apparatus of the second embodiment;

FIG. 5 is a first flowchart illustrating a level setting process (n=0) executed by a simulation apparatus of the second embodiment;

FIG. 6 is a second flowchart illustrating a level setting process (n=0) executed by a simulation apparatus of the second embodiment;

FIG. 7 is a flowchart illustrating a level setting process (n≥1) executed by a simulation apparatus of the second embodiment;

FIG. 8 is a flowchart illustrating a calculation process executed by a simulation apparatus of the second embodiment;

FIG. 9 is a flowchart illustrating a preconditioning procedure by an algebraic multigrid method executed by a simulation apparatus of the second embodiment;

FIG. 10 illustrates an example of a mesh model;

FIG. 11 illustrates an example of coarse graining of a mesh model;

FIG. 12 illustrates an example of a magnetic body mesh model; and

FIG. 13 is a table illustrating the number of iterations and calculation time in calculating a magnetostatic potential.

### DESCRIPTION OF EMBODIMENTS

Several embodiments will be described below with reference to the accompanying drawings, wherein like reference numerals refer to like elements throughout.

### First Embodiment

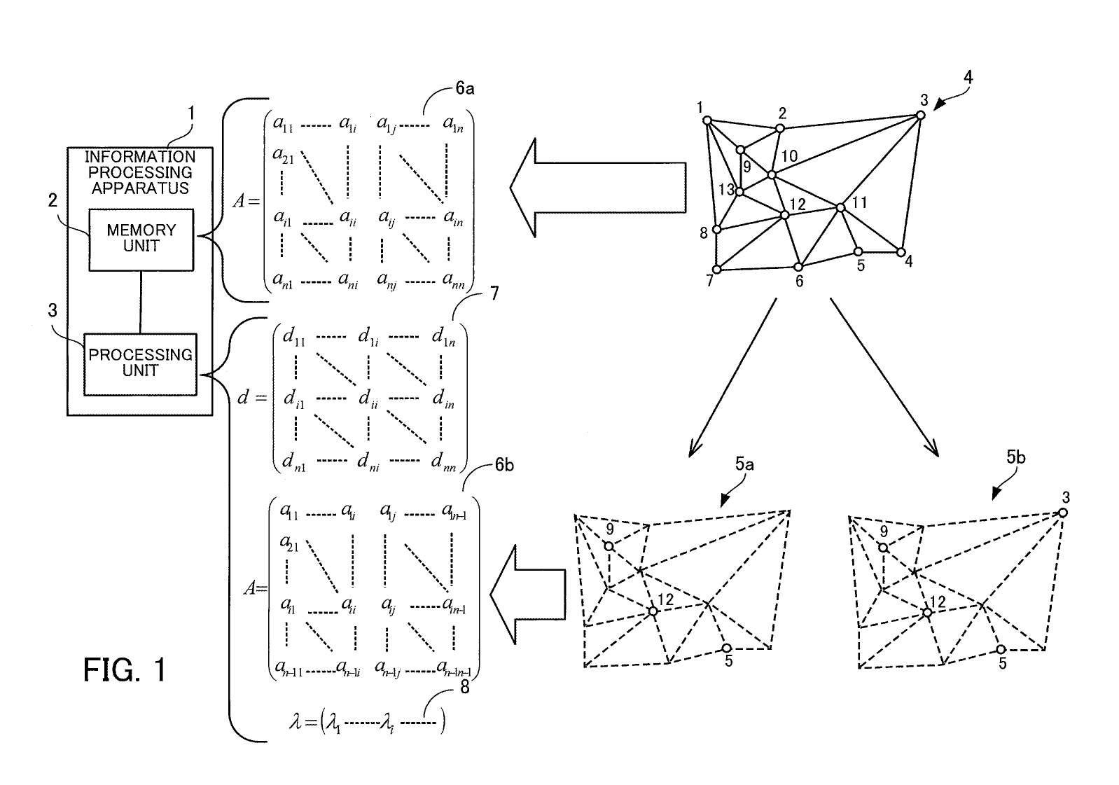

A first embodiment will be described with reference to FIG. 1. FIG. 1 illustrates an example of an information processing apparatus of the first embodiment.

The information processing apparatus 1 performs simulation, such as structural analysis, fluid analysis, and electromagnetic field analysis, on the basis of a mesh model created by dividing an object region and a space region of analysis target into a plurality of elements (sometimes referred to as mesh). The information processing apparatus 1 solves simultaneous equations by an iterative method and calculates a solution of variables associated with nodes (for example, magnetostatic potentials at nodes).

The information processing apparatus 1 includes a memory unit 2 and a processing unit 3. The memory unit 2 may be a volatile semiconductor memory, such as a random access memory (RAM), and may be a non-volatile memory, such as a hard disk drive (HDD) and a flash memory. The processing unit 3 is a processor, such as a central processing unit (CPU) and a digital signal processor (DSP). Note that the processing unit 3 may include an application specific electronic circuit, such as an application specific integrated circuit (ASIC) and a field programmable gate array (FPGA). The processor executes a program stored in the memory, such as the RAM. The program includes a simulation program for performing processes described later. A group of processors is referred to as “multiprocessor” or “processor” in some cases.

The memory unit 2 stores first matrix data 6a that includes, as components, coefficient values (aᵢⱼ (i, j=1, . . . , n)) indicating attributes between a plurality of nodes, with regard to a first mesh model 4 including a plurality of nodes. The elements in the first mesh model 4 are needless to be divided into grids. The first mesh model 4 includes distorted elements having a flat shape, a long and thin shape, a sharp shape having a node that is far from other nodes, and the like, in some cases. The first mesh model 4 may be generated by the information processing apparatus 1, and may be generated by another information processing apparatus. The memory unit 2 may store the first mesh model 4. The first matrix data 6a is created from the position coordinates of the nodes in the first mesh model 4, physical laws to be applied, and material data indicating material of the object of analysis target, for example. The first matrix data 6a may be created by the information processing apparatus 1, and may be created by another information processing apparatus.

The processing unit 3 creates distance data 7 indicating distances between the nodes, on the basis of the position coordinates of the nodes in the first mesh model 4. The distance data 7 is needless to include the distances between all combinations of nodes, but may include the distances between adjacent nodes only. The “distance” is expressed by Euclidean distance in the first mesh model 4, for example.

The processing unit 3 calculates threshold values which depend on the distances in the distance data corresponding to a plurality of pairs of nodes in the first mesh model 4. The threshold values are calculated such that a threshold value becomes larger as a distance becomes larger, for example. The processing unit 3 compares the threshold values and the coefficient values corresponding to the pairs of nodes indicated by the first matrix data 6a, and updates at least some of evaluation values, among a plurality of evaluation values corresponding to the plurality of nodes, on the basis of the comparison result. For example, when a coefficient value is larger than a threshold value, the processing unit 3 increases the evaluation value corresponding to one node in a pair of nodes. In this case, the evaluation value is more likely to increase as the distance is shorter, and is less likely to increase as the distance is longer.

The processing unit 3 selects some of the nodes on the basis of the evaluation values, creates a second mesh model 5a by excluding the selected nodes from the first mesh model 4, and generates second matrix data 6b for the second mesh model 5a. For example, the processing unit 3 determines that a node having a large evaluation value, among the nodes included in the first mesh model 4, is to be left in the second mesh model 5a preferentially, and that a node near the node having the large evaluation value is to be excluded from the second mesh model 5a. Then, the processing unit 3 calculates a solution of a plurality of variables associated with the plurality of nodes, by using the first matrix data 6a and the second matrix data 6b. The second matrix data 6b is used in the algebraic multigrid method as a preconditioning procedure of the iterative method, for example.

A simulation method executed by the information processing apparatus 1 having the above configuration will be described. In the information processing apparatus 1, the processing unit 3 first generates the distance data 7 indicating the distances between the nodes, on the basis of the position coordinates of the nodes in the first mesh model 4. For example, the processing unit 3 calculates the distances dᵢⱼ from the node i to the node j (i, j(≠i)=1, . . . , n), such as the distance d₁₂ from the node 1 to the node 2 and the distance d₂₃ from the node 2 to the node 3, in the mesh model 4, on the basis of the position coordinates of the nodes, and generates the distance data 7 that includes the distances dᵢⱼ as components.

Next, the processing unit 3 calculates threshold values εᵢⱼ which depend on the distances corresponding to the pairs of nodes and indicated by the distance data 7, with regard to the pairs of nodes in the first mesh model 4. Next, the processing unit 3 compares the threshold values εᵢⱼ and the coefficient values aᵢⱼ corresponding to the pairs of nodes indicated by the first matrix data 6a, and updates at least some of the evaluation values, among the plurality of evaluation values λⱼ corresponding to the plurality of nodes and included in the evaluation data 8, on the basis of the comparison result. For example, when a coefficient value aᵢⱼ is larger than a threshold value the processing unit 3 increases an evaluation value λᵢⱼ (for example, increases the evaluation value λⱼ by one). Note that the initial value of each evaluation value included in the evaluation data 8 is set to 0, for example.

Next, the processing unit 3 selects some of the nodes on the basis of the evaluation values λⱼ, creates the second mesh model 5a by excluding the selected nodes from the first mesh model 4, and generates the second matrix data 6b for the second mesh model 5a. Then, the processing unit 3 calculates a solution of the variables associated with the nodes, by using the first matrix data 6a and the second matrix data 6b.

By the way, a second mesh model 5b is created from the first mesh model 4 by another method for making the first mesh model 4 coarse. In the mesh model 5b, nodes 3, 5, 9, and 12 are selected from the first mesh model 4 including nodes 1 to 13, and the other nodes are excluded. The mesh model 5b differs from the mesh model 5a in that the node 3 is selected, and includes a distorted element having a sharp shape. When simultaneous equations are solved by using an iterative method on the basis of the second mesh model 5b, an error is reduced slowly, and the calculation is converged slowly. As a result, the number of iterations increases, and the calculation time increases significantly. Also, an approximate solution obtained by the iterative method becomes less accurate.

On the other hand, the information processing apparatus 1 compares threshold values which depend on the distances of the distance data 7 indicating the distances between the nodes in the first mesh model 4, with the coefficient values corresponding to the pairs of nodes and indicated by the first matrix data 6a, and updates at least some of the evaluation values corresponding to the nodes on the basis of the comparison result. The information processing apparatus 1 generates the second matrix data 6b for the second mesh model 5a created by excluding some of the nodes in the first mesh model 4 selected on the basis of the evaluation values. Then, the information processing apparatus 1 calculates a solution of the variables associated with the nodes by using the first matrix data 6a and the second matrix data 6b. Thereby, the information processing apparatus 1 speeds up the convergence of the calculation by the iterative method. As a result, the number of iterations decreases, and the calculation time decreases. In addition, the approximate solution obtained by the iterative method becomes more accurate.

### Second Embodiment

Next, the second embodiment will be described.

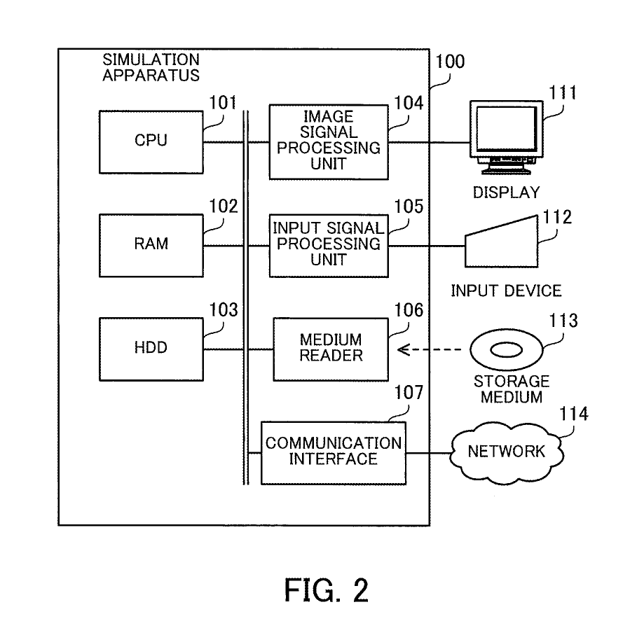

FIG. 2 is a block diagram illustrating a hardware example of a simulation apparatus of a second embodiment.

The simulation apparatus 100 includes a CPU 101, a RAM 102, an HDD 103, an image signal processing unit 104, an input signal processing unit 105, a medium reader 106, and a communication interface 107. The above units in the simulation apparatus 100 are connected to a bus. Note that the simulation apparatus 100 corresponds to the information processing apparatus 1 of the first embodiment. The RAM 102 or the HDD 103 corresponds to the memory unit 2 of the first embodiment. The CPU 101 corresponds to the processing unit 3 of the first embodiment.

The CPU 101 is a processor including a computing circuit that executes commands of programs. The CPU 101 loads at least part of programs and data stored in the HDD 103 into the RAM 102, and executes the programs. Note that the CPU 101 may include a plurality of processor cores, and the simulation apparatus 100 may include a plurality of processors, so that the process described below is executed in parallel by using the plurality of processors or processor cores. Also, a group of processors (multiprocessor) may be called “processor”.

The RAM 102 is a volatile semiconductor memory that temporarily stores programs executed by the CPU 101 and data that the CPU 101 uses in calculation. Note that the simulation apparatus 100 may include a memory of a type other than the RAM, and may include a plurality of memories.

The HDD 103 is a non-volatile storage device for storing programs and data of an operating system (OS), middleware, and software such as application software. A simulation program is included in the programs. Note that the simulation apparatus 100 may include a memory device of another type, such as a flash memory and a solid state drive (SSD), and may include a plurality of non-volatile memory devices.

The image signal processing unit 104 outputs an image to a display 111 connected to the simulation apparatus 100, in accordance with a command from the CPU 101. The display 111 may be various types of displays, such as a cathode ray tube (CRT) display, a liquid crystal display (LCD), a plasma display, and an organic electro-luminescence (OEL) display.

The input signal processing unit 105 receives an input signal from an input device 112 connected to the simulation apparatus 100, and outputs the received input signal to the CPU 101. The input device 112 is, for example, a pointing device, such as a mouse, a touch panel, a touch pad, and a trackball, as well as a keyboard, a remote controller, and a button switch. Also, a plurality of types of input devices may be connected to the simulation apparatus 100.

The medium reader 106 is a reader device for reading programs and data stored in a storage medium 113. The storage medium 113 is, for example, a magnetic disk, an optical disc, a magneto-optical disk (MO), a semiconductor memory, or the like. The magnetic disk includes a flexible disk (FD) and an HDD. The optical disc includes a compact disc (CD) and a digital versatile disc (DVD).

For example, the medium reader 106 copies the programs and data read from the storage medium 113 in another storage medium, such as the RAM 102 and the HDD 103. The read programs are executed by the CPU 101, for example. Note that the storage medium 113 may be a portable storage medium, which is used to distribute the programs and data. The storage medium 113 and the HDD 103 are sometimes referred to as computer-readable storage medium.

The communication interface 107 is connected to a network 114 and communicates with another device via the network 114. The communication interface 107 may be a wired communication interface connected to a communication device, such as a switch, via a cable, and may be a wireless communication interface connected to a base station via a wireless link.

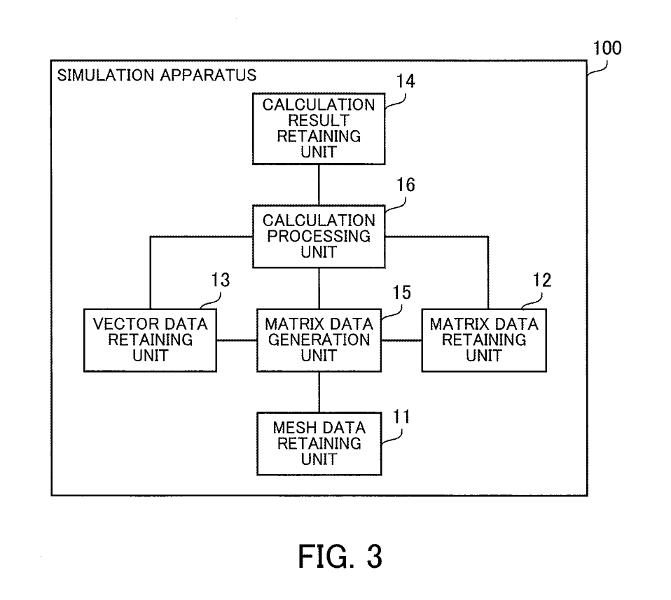

Next, the functional blocks that represent the functions provided by the simulation apparatus will be described with reference to FIG. 3. FIG. 3 is a block diagram illustrating the functional blocks representing the functions of the simulation apparatus of the second embodiment.

The simulation apparatus 100 generates simultaneous equations expressed by equation (1) from a mesh model created by dividing an object region and a space region into a plurality of elements, and calculates a solution of the simultaneous equations.

Ax=b (1)

Here, A is a coefficient matrix (mesh matrix data); x is a solution vector; and b is a right-side vector.

The simulation apparatus 100 includes a mesh data retaining unit 11, a matrix data retaining unit 12, a vector data retaining unit 13, and a calculation result retaining unit 14. The mesh data retaining unit 11, the matrix data retaining unit 12, the vector data retaining unit 13, and the calculation result retaining unit 14 are implemented by using a memory region allocated in the RAM 102 or the HDD 103, for example. In addition, the simulation apparatus 100 includes a matrix data generation unit 15 and a calculation processing unit 16. The matrix data generation unit 15 and the calculation processing unit 16 are implemented by using program modules executed by the CPU 101, for example.

The mesh data retaining unit 11 retains a plurality of nodes included in the mesh model and the position coordinates of the nodes. The mesh data stored in the mesh data retaining unit 11 may be generated by the simulation apparatus 100 on the basis of a two-dimensional or three-dimensional model created by mesh creation software, such as computer aided design (CAD) software. The surface shape of an analysis target is input by a user to the mesh creation software, for example. Then, the mesh creation software automatically creates a model by dividing an inner region and a surrounding region of the analysis target with lines. In this model expressed with the lines, the position coordinates of intersection points (nodes) between different lines have not been calculated. The simulation apparatus 100 acquires the model expressed with the lines created by the simulation apparatus 100 or a model expressed with lines input from another device, and calculates the position coordinates of the nodes from the model expressed with the lines, in order to generate the above mesh data. Note that the above mesh model may be created outside the simulation apparatus 100 and be input to the simulation apparatus 100.

The matrix data retaining unit 12 retains various types of matrix data generated by the simulation apparatus 100. The matrix data is, for example, a projection matrix, mesh matrix data indicating a coefficient matrix of simultaneous equations, and mesh distance data.

The vector data retaining unit 13 retains various types of vector data used in the simulation apparatus 100. The vector data is, for example, an evaluation vector, a solution vector, and a right-side vector.

The calculation result retaining unit 14 retains information of a result calculated by the simulation apparatus 100. The calculation result retained by the calculation result retaining unit 14 is an ultimate solution vector. The simulation apparatus 100 outputs the calculation result retained by the calculation result retaining unit 14 to an output device in various forms, such as displaying the calculation result on the display 111. For example, the simulation apparatus 100 may display the values of the variables in the solution vector on the display 111. Also, the simulation apparatus 100 may map and display the calculation result on a two-dimensional or three-dimensional model. It is conceived that an arrow, a symbol, a pattern, or the like indicating a physical quantity, such as a magnetostatic potential, are displayed (visualized) in association with each node on the model.

The matrix data generation unit 15 generates a projection matrix and a coefficient matrix. Also, the matrix data generation unit 15 selects the nodes that are to be excluded for the purpose of coarse graining at each level, while updating the evaluation vector data, in order to generate the mesh matrix data and the mesh distance data. The coefficient matrix used in the zeroth level (the original coefficient matrix corresponding to the finest mesh model) is a square matrix in which the number of rows and the number of columns are each equal to the number of nodes in the mesh data retained by the mesh data retaining unit 11. Also, the solution vector and the right-side vector used in the zeroth level are column vectors in which the number of rows is the number of nodes in the mesh data retained by the mesh data retaining unit 11. The matrix data generation unit 15 generates the coefficient matrix and the right-side vector for use in the zeroth level, from the mesh data retained by the mesh data retaining unit 11 and a predetermined equation expressing a physical law.

Here, the matrix data generation unit 15 may refer to material data indicating the material of the analysis target or a physical property value relevant to the material. The material data is stored in the mesh data retaining unit 11 in association with the mesh data, for example. The material data may be input by the user, and may be generated by software, such as CAD software.

The calculation processing unit 16 executes a calculation process of the simultaneous equation (1) of the simulation target by using the matrix data and the vector data. Also, the calculation processing unit 16 performs a preconditioning procedure by the algebraic multigrid method, during this calculation process.

In the simulation apparatus 100 having this function, the matrix data generation unit 15 first generates the matrix data and the vector data used in the subsequent calculation process. In this creation, the matrix data generation unit 15 selects the nodes (coarse (C) points) that are validated by coarse graining and belong to the (n+1)th level, which is one level lower than the n-th level, from among the nodes in the n-th level, for example. Further, the matrix data generation unit 15 selects the nodes (fine (F) points) that are invalidated in the (n+1)th level by the coarse graining, from among the nodes in the n-th level. The matrix data generation unit 15 generates matrix data, vector data, etc. in each level. Then, the calculation processing unit 16 executes a calculation process to the simulation target by using the matrix data and the vector data generated by the matrix data generation unit 15.

Note that, in the present embodiment, the zeroth level is the highest level, and the level that is one level lower than the zeroth level is the first level. That is, the level that is one level lower than the n-th level is the (n+1)th level.

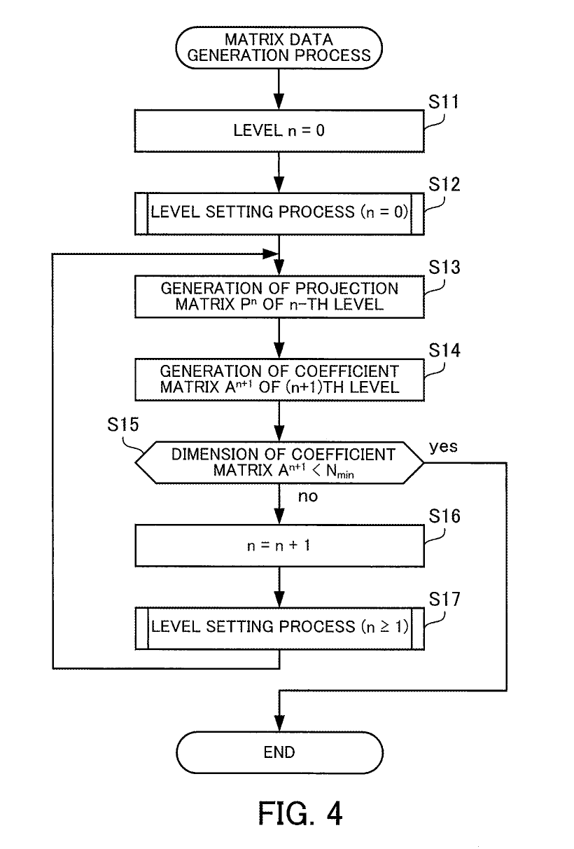

Next, a matrix data generation process executed by the matrix data generation unit 15 in the simulation apparatus 100 will be described with reference to FIG. 4. In an iterative method that uses the algebraic multigrid method as a preconditioning procedure, the preconditioning procedure is repeatedly performed, and an approximate solution is repeatedly updated by using the result of the preconditioning procedure. A plurality of mesh models (i.e., a plurality of coefficient matrices) of different sizes are repeatedly used for the algebraic multigrid method during the iterative calculation. Hence, the matrix data generation unit 15 may generate a plurality of coefficient matrices only once by the method described below, before the calculation processing unit 16 starts the iterative calculation.

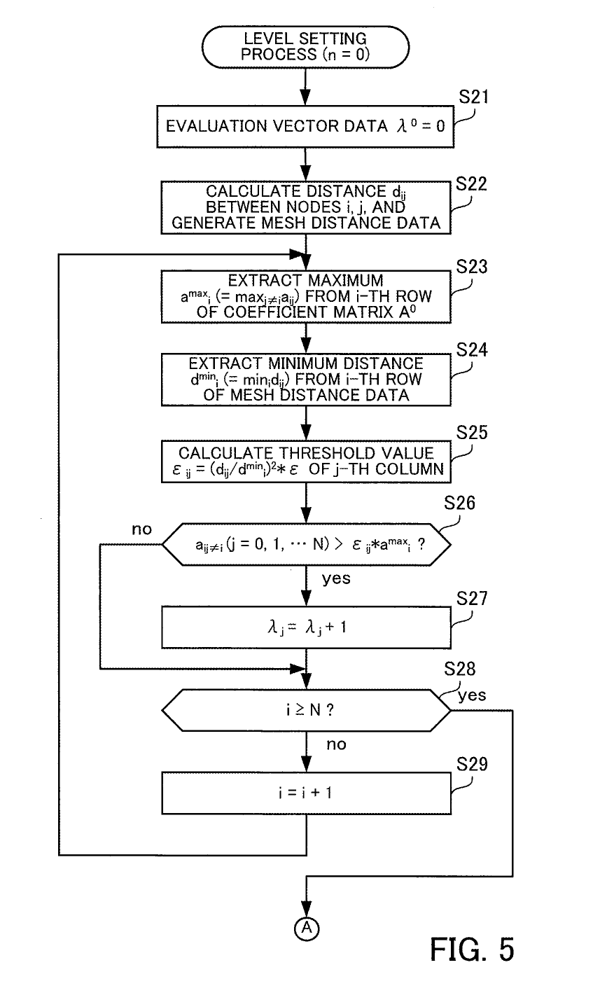

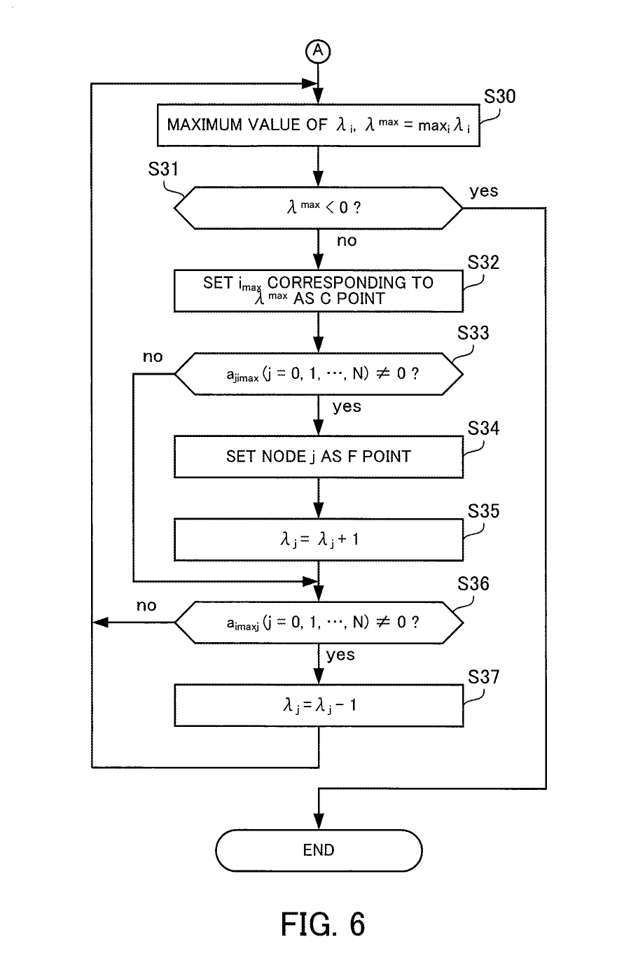

FIG. 4 is a flowchart illustrating the matrix data generation process executed by the simulation apparatus of the second embodiment. The matrix data generation unit 15 of the simulation apparatus 100 executes the below process.

[Step S11] The matrix data generation unit 15 sets the current level to the zeroth level (n=0).

[Step S12] The matrix data generation unit 15 executes a level setting process (n=0) for classifying a plurality of nodes included in the zeroth level into C points and F points by using the mesh matrix data and the distances between the nodes of the mesh model. Detail of the level setting process (n=0) of step S12 will be described later (FIGS. 5 and 6).

[Step S13] The matrix data generation unit 15 generates the n-th projection matrix Pₙ on the basis of the C points and the F points of the n-th level. Here, in the algebraic multigrid method, a solution search process, which is called smoothing, is performed in a certain level to calculate the approximation values and the residuals corresponding to the respective nodes, and the residuals are transferred to the level ranked one level lower. In the lower level, the residuals transferred from the higher level are set to the right-side vector, in order to perform the smoothing. This is repeated until the lowermost level is reached. In the lowermost level, the coefficient matrix is sufficiently small, and therefore the approximation values corresponding to respective nodes are solved by a direct method and are transferred to the level one level higher. In the higher level, the approximation values (perturbation amounts) relevant to the residuals transferred from the lower level are added to the approximation values of the higher level calculated previously, and the approximation values of the higher level are smoothed and updated. This is repeated until the level reaches the zeroth level.

Transmission from a higher level to a lower level is sometimes referred to as “restriction”, and transmission from a lower level to a higher level is sometimes referred to as “prolongation”. When the residual vector of a higher level is converted to the right-side vector of a lower level, ^{T}Pₙ which is a transposed matrix of the projection matrix Pₙ is used. On the other hand, when the solution relevant to the residuals calculated in a lower level is fed back to a higher level, the projection matrix Pₙ is used.

In this projection matrix Pⁿ, the number of rows is equal to the number of nodes in the n-th level, and the number of columns is equal to the number of nodes of the C points in the n-th level (i.e., the number of nodes in the (n+1)th level). The projection matrix Pₙ is generated by below equation (2).

$${P}_{ij} = \{ \begin{matrix}{δ}_{ij} ( i ∈ C ) \\ {g}_{ij} ( i ∈ F )\end{matrix} \qquad ( 2 )$$

In equation (2), i is a node number indicating a node of the n-th level, and j is a node number indicating a node of the (n+1)th level. That is, Pᵢⱼ =δᵢⱼ is established when the node i is included in the collection of C points, and Pᵢⱼ=gᵢⱼ is established when the node i is included in the collection of F points. Here, δᵢⱼ of equation (2) is expressed by below equation (3), and gᵢⱼ is expressed by below equation (4).

$${δ}_{ij} = \{ \begin{matrix}1 ( i = j ) \\ 0 ( i \neq j )\end{matrix} \qquad ( 3 )$$

In equation (3), δᵢⱼ is a Kronecker delta. That is, when the node i and the node j are the same as each other, the component of the projection matrix Pₙ corresponding to the pair of nodes i, j becomes “1”, and when the node i and the node j are different from each other, the component of the projection matrix Pₙ corresponding to the pair of nodes i, j becomes “0”.

$${g}_{ij} = - \frac{1}{{a}_{ii}} ( {a}_{ij} + {\sum }_{k ∈ F}^{ } \frac{{a}_{ik} {a}_{kj}}{{a}_{jj}} ) \qquad ( 4 )$$

In equation (4), k is included in the collection of F points. In equation (4), gᵢⱼ is obtained by adding a dependence degree of the node i on the node j to a sum of dependence degrees of the node i on the node j via the nodes k which are other F points. That is, gᵢⱼ expresses superimposition of the dependence degrees, on the node j, of the nodes i that disappear by coarse graining.

When “restriction” is performed from a higher level to a lower level by using this projection matrix Pⁿ, the value associated with a certain node being a C point remains at the node in the lower level. On the other hand, when a certain node is an F point, the value associated with the node is dispersed and transferred to nearby C points. Also, when “prolongation” is performed from a lower level to a higher level by using this projection matrix Pⁿ, the value associated with a node (C point) of the lower level remains at the node in the higher level. On the other hand, the value associated with a node (F point) that does not exist in the lower level is interpolated on the basis of the values associated with nearby C points.

[Step S14] The matrix data generation unit 15 makes the coefficient matrix Aₙ of the n-th level coarse, and generates the coefficient matrix Aⁿ⁺¹ of the (n+1)th level in which the number of rows and the number of columns have decreased from the coefficient matrix Aⁿ.

The coefficient matrix Aⁿ⁺¹ is generated by below equation (5).

Aⁿ⁺¹=^{T}PⁿAⁿP (5)

Note that the coefficient matrix Aⁿ⁺¹ obtained as described above is a square matrix in which the number of rows and the number of columns are each equal to the number of nodes of C points set in step S12.

[Step S15] The matrix data generation unit 15 determines whether or not the dimension of the coefficient matrix Aⁿ⁺¹ is smaller than a predetermined minimum dimension Nₘᵢₙ. For example, a threshold value Nₘᵢₙ is a fixed value or is given by a user.

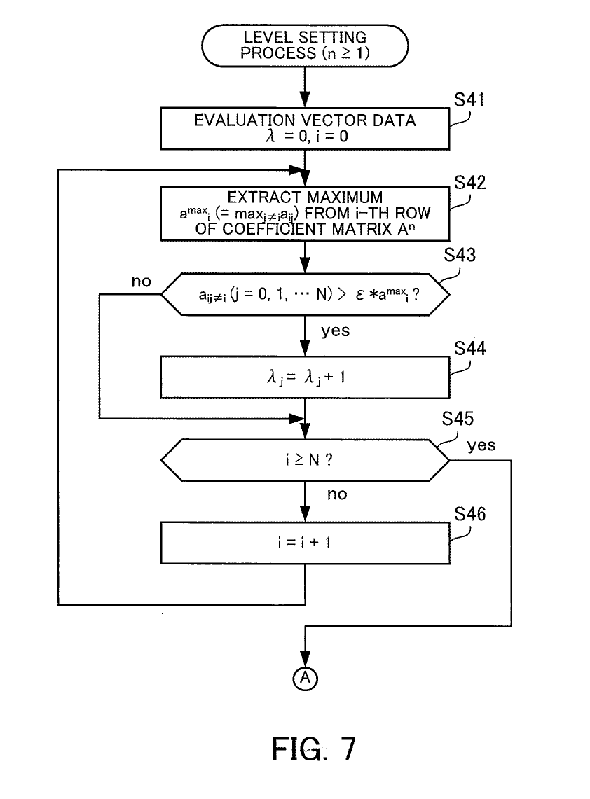

Then, the process ends the matrix data generation process if the dimension of the coefficient matrix Aⁿ⁺¹ is smaller than the minimum dimension Nₘᵢₙ, and proceeds to step S16 if the dimension of the coefficient matrix Aⁿ⁺¹ is not smaller than the minimum dimension Nₘᵢₙ (is equal to or larger than Nₘᵢₙ).

[Step S16] The matrix data generation unit 15 lowers the current level to a level ranked one level lower, and set the level as the (n+1)th level.

[Step S17] The matrix data generation unit 15 executes a level setting process for classifying a plurality of nodes included in the n-th level (n≥1) into C points and F points, by using mesh matrix data. As described later, the level setting process of the first or subsequent levels differs from the level setting process of the zeroth level. Note that the level setting process of the first or subsequent levels may be performed by the same method as the zeroth level. Next, the process proceeds to step S13 again. Detail of the level setting process (n≥1) of step S17 will be described later (FIGS. 7 and 6).

Next, step S12 of the matrix data generation process (FIG. 4) will be described with reference to FIGS. 5 and 6. FIGS. 5 and 6 are flowcharts illustrating the level setting process (n=0) executed by the simulation apparatus of the second embodiment. The matrix data generation unit 15 of the simulation apparatus 100 executes the below process.

[Step S21] The matrix data generation unit 15 sets an initial value 0 to the evaluation values A (J=0, 1, . . . , N), which are the components of evaluation vector data λ, associated with the nodes in the zeroth level. Note that N is the number of nodes.

The ultimate evaluation vector data λ is a row vector composed of j columns of evaluation values λⱼ (j=0, 1, . . . , N), and an evaluation value λⱼ indicate the number of other nodes intensely dependent on the node j.

[Step S22] The matrix data generation unit 15 calculates distances dᵢⱼ between two nodes i, j on the basis of the position coordinates of the nodes in the zeroth level. The matrix data generation unit 15 generates mesh distance data that includes the calculated distances dᵢⱼ as components.

Here, the matrix data generation unit 15 is needless to calculate the distances between all pairs of nodes, but may calculate the distances between adjacent nodes only. The matrix data generation unit 15 calculates distances between a certain node and other nodes that belong to the same element as the certain node, with regard to each node, for example. It is possible that one node belongs to a plurality of elements. For example, nodes 1, 2, 3, and 4 form a tetrahedron element; nodes 1, 2, 5, and 6 form a tetrahedron element; and nodes 7, 8, 9, and 10 form a tetrahedron element. The node 1 belongs to two elements. In this case, the matrix data generation unit 15 calculates the distances between the node 1 and the nodes 2, 3, 4, 5, and 6. The distances between the node 1 and the nodes 7, 8, 9, and 10 are needless to be calculated.

Moreover, i is set to 0 as the initial value of i used below.

[Step S23] The matrix data generation unit 15 extracts the maximum coefficient max_{j≠i}aᵢⱼ from among the non-zero components of the i-th row of the coefficient matrix A⁰ except the diagonal component satisfying i=j, and sets the maximum coefficient max_{j≠i}aᵢⱼ as a^{max}i.

[Step S24] The matrix data generation unit 15 extracts the minimum distance minᵢdᵢⱼ from among the non-zero components of the i-th row of the mesh distance data, and sets the minimum distance minᵢdᵢⱼ as d^{min}ᵢ.

The matrix data generation unit 15 executes below steps S25 to S27 for j=0, 1, . . . , N. Note that j is assumed to be different from i.

[Step S25] The matrix data generation unit 15 calculates εᵢⱼ applied to the component of the i-th row and the j-th column of the coefficient matrix A⁰, from below equation (6), by using the minimum distance d^{min}ᵢ and the distance dᵢⱼ between the node i and the node j.

$${ɛ}_{ij} = {( \frac{{d}_{ij}}{{d}_{i}^{m i n}} )}^{2} ɛ \qquad ( 6 )$$

In equation (6), is a predetermined value set within a range of 0<ε<1. Here, may be a fixed value, and may be set by the user. Note that εᵢⱼ is larger, as the distance dᵢⱼ is larger.

[Step S26] The matrix data generation unit 15 calculates threshold values εᵢⱼ×a^{max}ᵢ from εᵢⱼ of step S25 and a^{max}ᵢ of step S23. The matrix data generation unit 15 compares a threshold value and a component aᵢⱼ of the i-th row and j-th column of the coefficient matrix A⁰, and determines whether below inequality (7) is satisfied. That is, the matrix data generation unit 15 determines whether aᵢⱼ is larger than εᵢⱼa^{max}ᵢ.

a_{ij≠i}(j=0, 1, . . . , N)>εᵢⱼ*aᵢ^{max} (7)

Next, the process proceeds to step S27 if inequality (7) is satisfied, and proceeds to step S28 if inequality (7) is not satisfied.

[Step S27] The matrix data generation unit 15 adds 1 to the evaluation value A corresponding to j that satisfies inequality (7), in the evaluation vector data λ.

[Step S28] The matrix data generation unit 15 determines whether or not i is equal to or larger than the number N of nodes.

Next, the process proceeds to step S30 (FIG. 6) if i is equal to or larger than N, and proceeds to step S29 if i is not equal to or larger than N (i is smaller than N).

[Step S29] The matrix data generation unit 15 adds 1 to the current i, and then the process proceeds to step S23, again.

[Step S30] The matrix data generation unit 15 extracts the maximum evaluation value maxᵢλᵢ from among the evaluation values λᵢ that are included in the evaluation vector data and correspond to the nodes that have not been classified into F points or C points, and sets the extracted maximum evaluation value maxᵢλᵢ as λ^{max}.

[Step S31] The matrix data generation unit 15 determines whether or not the maximum evaluation value λₘₐₓ is smaller than 0.

Next, the process ends the level setting process (n=0) if the maximum evaluation value λ^{max} is smaller than 0, and proceeds to step S32 if the maximum evaluation value λ^{max} is not smaller than 0 (the evaluation value λ^{max} is equal to or larger than 0). Note that the process ends the level setting process (n=0) if a node that has not been classified into C points or F points do not exist.

[Step S32] The matrix data generation unit 15 sets the node iₘₐₓ corresponding to the maximum evaluation value λ^{max} as a C point.

[Step S33] The matrix data generation unit 15 determines whether or not the component aⱼᵢₘₐₓ (j=0, 1, . . . , N) of the j-th row and iₘₐₓ-th column of the coefficient matrix A⁰ is 0 (whether or not the node iₘₐₓ depends on the node j), with regard to each of the nodes j that have not been classified into C points or F points.

Next, the process proceeds to step S34 if the node j at which aⱼᵢₘₐₓ is not 0 exists, and proceeds to step S36 if such a node j does not exist.

[Step S34] The matrix data generation unit 15 sets the node j that satisfies step S33 as an F point.

[Step S35] The matrix data generation unit 15 adds 1 to the evaluation value λⱼ corresponding to the node j that satisfies step S33, in the evaluation vector data λ.

[Step S36] The matrix data generation unit 15 determines whether or not the component aᵢₘₐₓⱼ (j=0, 1, . . . , N) of the iₘₐₓ-th row and the j-th column of the coefficient matrix A⁰ is 0 (whether or not the node j depends on the node iₘₐₓ (C point)), with regard to each of the nodes j that have not been classified into C points or F points.

Next, the process proceeds to step S37 if the node j at which aᵢₘₐₓⱼ is not 0 exists, and proceeds to step S30 if such a node j does not exist.

[Step S37] The matrix data generation unit 15 subtracts 1 from the evaluation value λⱼ corresponding to the node j that satisfies step S36 in the evaluation vector data λ.

Next, step S17 of the matrix data generation process (FIG. 4) will be described with reference to FIG. 7 (and FIG. 6). FIG. 7 is a flowchart illustrating a level setting process (n≥1) executed by the simulation apparatus of the second embodiment. The matrix data generation unit 15 of the simulation apparatus 100 executes the following process.

[Step S41] The matrix data generation unit 15 sets an initial value 0 to the evaluation values λⱼ (j=0, 1, . . . , N), which are the components of the evaluation vector data A associated with the nodes in the n-th level (n≥1). Also, the matrix data generation unit 15 sets the initial value of i to 0.

[Step S42] The matrix data generation unit 15 extracts the maximum coefficient max_{j≠i}aᵢⱼ from among the non-zero components of the i-th row of the coefficient matrix Aₙ except the diagonal component satisfying i=j, and sets the extracted maximum coefficient max_{j≠i}aᵢⱼ as a^{max}ᵢ.

The matrix data generation unit 15 executes below steps S43 and S44 for j=0, 1, . . . , N. Note that j is assumed to be different from i.

[Step S43] The matrix data generation unit 15 calculates a threshold value ε×a^{max}ᵢ from εand a^{max}ᵢ of step S42. The matrix data generation unit 15 compares the threshold value and the component aᵢⱼ of the i-th row and j-th column of the coefficient matrix A⁰, and determines whether below inequality (8) is satisfied. That is, the matrix data generation unit 15 determines whether aᵢⱼ is larger than ε×a^{max}ᵢ.

a_{ij≠i}(j=0, 1, . . . , N)>ε*aᵢ^{max} (8)

In inequality (8), ε is a predetermined value set within a range of 0<ε<1, likewise equation (6).

Next, the process proceeds to step S44 if inequality (8) is satisfied, and proceeds to step S45 if inequality (8) is not satisfied.

[Step S44] The matrix data generation unit 15 adds 1 to the evaluation value λⱼ corresponding to j that satisfies inequality (8), in the evaluation vector data λ.

[Step S45] The matrix data generation unit 15 determines whether or not i is equal to or larger than the number N of nodes.

Next, the process proceeds to step S30 (FIG. 6) if i is equal to or larger than N, and proceeds to step S46 if i is not equal to or larger than N (i is smaller than N).

Note that, after step S30, the process is executed along the flowchart illustrated in FIG. 6, and each node is classified into C points or F points.

[Step S46] The matrix data generation unit 15 adds 1 to the current i, and then the process proceeds to step S42, again.

Note that, in the second embodiment, the level setting process (n≥1) (FIGS. 7 and 6) is executed in step S17 of the matrix data generation process (FIG. 4). Instead of this, in the step S17, the same process as the level setting process (n=0) (FIGS. 5 and 6) may be performed in the n-th level (n≥1).

The simulation apparatus 100 performs coarse graining of the mesh model as described above and generates coarse matrix data for each level, and the calculation processing unit 16 executes a calculation process.

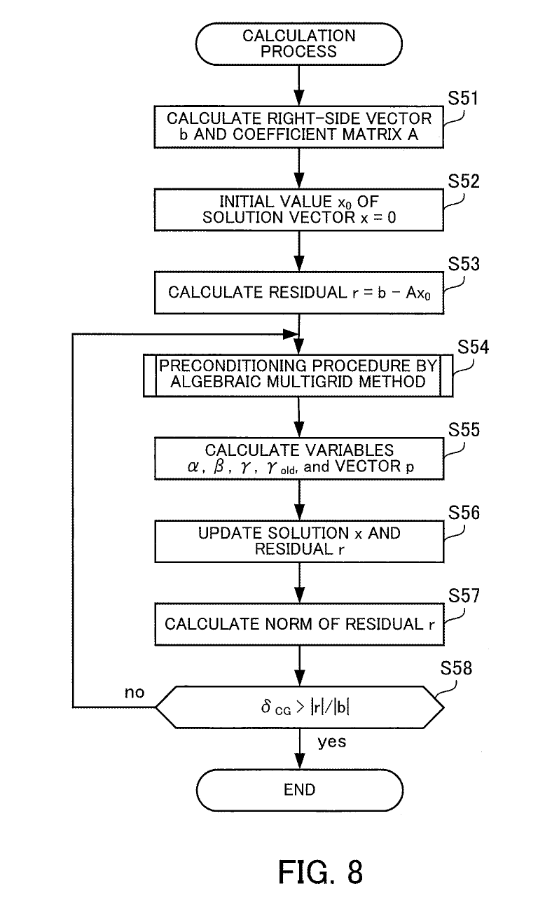

Next, the calculation process executed by the calculation processing unit 16 will be described with reference to FIG. 8. FIG. 8 is a flowchart illustrating the calculation process executed by the simulation apparatus of the second embodiment. The calculation processing unit 16 of the simulation apparatus 100 executes the below process.

[Step S51] The calculation processing unit 16 calculates the right-side vector b and the coefficient matrix A(=A⁰) of equation (1), from the mesh data retained by the mesh data retaining unit 11 and a predetermined equation representing a physical law. Here, the calculation processing unit 16 may refer material data indicating material of the object of the simulation target.

[Step S52] The calculation processing unit 16 sets an initial value x₀ of a solution vector x to 0.

[Step S53] The calculation processing unit 16 calculates the residual r obtained when the approximate solution is x₀, which is expressed by below equation (9). Also, the calculation processing unit 16 sets the initial value of the variable γ to 0, and sets the initial value of the vector p to 0.

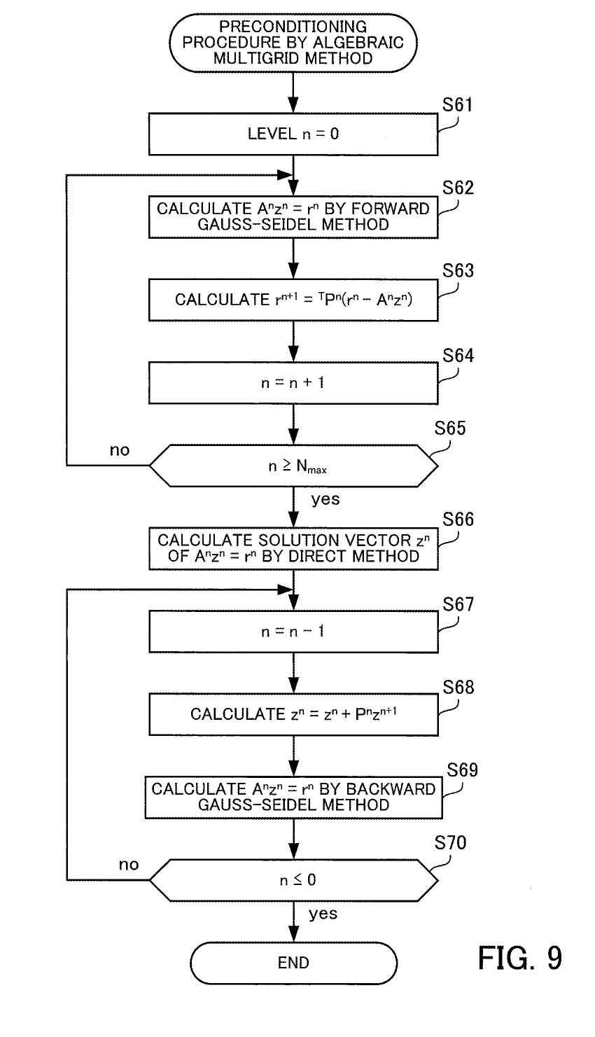

r=b−Ax₀ (9)

[Step S54] The calculation processing unit 16 calculates a vector z corresponding to the solution vector x by executing a preconditioning procedure by the algebraic multigrid method. Detail of the preconditioning procedure by the algebraic multigrid method of step S54 will be described later (FIG. 9).

[Step S55] The calculation processing unit 16 calculates variables α, β, γ, γ_{old} and the vector p by using equations (10) to (14). That is, the calculation processing unit 16 updates the variable γ by using the vector z obtained by the preconditioning procedure and the last residual r, and updates the variable β from the value (γ_{old}) of the variable γ before the update and the value of the variable γ after the update. Then, the calculation processing unit 16 updates the vector p by using the vector z obtained by the preconditioning procedure and the updated variable β, and updates the variable α by using the vector p, the coefficient matrix A, and the variable γ.

$$\begin{matrix}{γ}_{old} = γ & ( 10 ) \\ γ = z \cdot r & ( 11 ) \\ β = \frac{γ}{{γ}_{old}} & ( 12 )\end{matrix}$$

Note that β is set to 0, in the case of γ_{old}=0.

$$\begin{matrix}p = z + β p & ( 13 ) \\ α = \frac{γ}{( p \cdot Ap )} & ( 14 )\end{matrix}$$

Note that p·Ap indicates the inner product between p and Ap.

[Step S56] The calculation processing unit 16 updates the solution vector x (approximate solution) by applying the variable α and the vector p to equation (15).

x=x+αp (15)

Also, the calculation processing unit 16 updates the residual r by applying the variable α, the coefficient matrix A, and the vector p to equation (16).

r=r−αAp (16)

[Step S57] The calculation processing unit 16 calculates the norm (absolute value) of the residual r.

[Step S58] The calculation processing unit 16 determines whether or not the norm of the residual r satisfies δ_{CG}>|r|/|b| with reference to a predetermined threshold value δ_{CG} (i.e., whether or not the residual r has converged sufficiently).

Next, the process ends the calculation process if δ_{CG}>|r|/|b| is satisfied (the residual r has converged sufficiently), and again proceeds to step S54 if δ_{CG}>|r|/|b| is not satisfied (the residual r has not converged sufficiently).

Next, step S54 of the calculation process (FIG. 8) will be described with reference to FIG. 9. FIG. 9 is a flowchart illustrating a preconditioning procedure by the algebraic multigrid method executed by the simulation apparatus of the second embodiment. The calculation processing unit 16 of the simulation apparatus 100 executes the below process.

[Step S61] The calculation processing unit 16 sets the current level to the zeroth level (n=0).

[Step S62] The calculation processing unit 16 calculates below equation (17) at least once by the forward Gauss-Seidel method by utilizing the coefficient matrix Aₙ of the n-th level, with respect to the simultaneous equations Aⁿzₙ=rⁿ. The equation (17) may be repeated twice or more. Note that r⁰ (r of the zeroth level) is the residual r calculated in S53. The initial value of z is 0.

$${z}_{i}^{new} = \frac{1}{{a}_{ii}} ( {r}_{i} - {\sum }_{j = 0}^{i - 1} {a}_{ij} {z}_{j}^{new} - {\sum }_{j = i + 1}^{N} {a}_{ij} {z}_{j}^{old} ) \qquad ( 17 )$$

[Step S63] The calculation processing unit 16 calculates the right-side vector rⁿ⁺¹ of the (n+1)th level ranked one level lower than the n-th level, by using below equation (18).

rⁿ⁺¹=^{T}Pⁿ(rⁿ−Aⁿzⁿ) (18)

[Step S64] The calculation processing unit 16 lowers the level of interest to the level ranked one level lower. That is, the calculation processing unit 16 adds 1 to n.

[Step S65] The calculation processing unit 16 determines whether or not n is equal to or larger than predetermined Nₘₐₓ. Nₘₐₓ may be a fixed value, and may be set by the user. Next, if n is equal to or larger than Nₘₐₓ, the process proceeds to step S66. On the other hand, if n is not equal to or larger than Nₘₐₓ (n is smaller than Nₘₐₓ), the process proceeds to step S62.

[Step S66] The calculation processing unit 16 calculates a vector zⁿ, which is the solution of the simultaneous equations Aⁿzⁿ=rⁿ, by a direct method.

[Step S67] The calculation processing unit 16 raises the level of interest to the level ranked one level higher. That is, the calculation processing unit 16 subtracts 1 from n.

[Step S68] The calculation processing unit 16 updates the vector zⁿ, which is the solution of the n-th level, by using below equation (19).

Zₙ=Zⁿ+Pⁿzⁿ⁺¹ (19)

Note that the vector zₙ of the n-th level of equation (19) is obtained by adding the contribution from the (n+1)th level ranked one level lower (the vector zⁿ⁺¹ of the (n+1)th level converted by using the projection matrix Pₙ of the n-th level) to the vector Zⁿ.

[Step S69] The calculation processing unit 16 calculates below equation (20) at least once by a backward Gauss-Seidel method by utilizing the coefficient matrix Aₙ of the n-th level, with respect to the simultaneous equations Aⁿzₙ=rⁿ. The equation (20) may be repeated twice or more.

$${z}_{i}^{new} = \frac{1}{{a}_{ii}} ( {r}_{i} - {\sum }_{j = 0}^{i - 1} {a}_{ij} {z}_{j}^{old} - {\sum }_{j = i + 1}^{N} {a}_{ij} {z}_{j}^{new} ) \qquad ( 20 )$$

[Step S70] The calculation processing unit 16 determines whether or not n is equal to or smaller than 0. Next, the process ends the preconditioning procedure by the algebraic multigrid method if n is equal to or smaller than 0, and proceeds to step S67 again if n is not equal to or smaller than 0 (n is larger than 0).

As described above, in the simulation apparatus 100, the calculation processing unit 16 performs the calculation process and calculates the solution of the simultaneous equations.

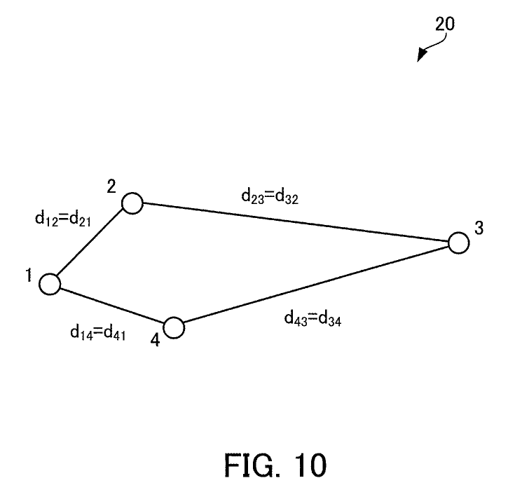

Here, a specific example of the level setting process (n=0) that the matrix data generation unit 15 executes along the flowchart (FIGS. 5 and 6) to set the nodes included in the zeroth level to C points and F points will be described with reference to FIG. 10.

FIG. 10 illustrates an example of a mesh model. The mesh model 20 includes four nodes (nodes 1 to 4) as illustrated in FIG. 10, and the nodes 1 to 4 belong to the zeroth level. In this mesh model 20, the node 3 is located far from other nodes and makes the element distorted.

First, the matrix data generation unit 15 sets an initial value 0 to the evaluation values λ₁ to λ₄, which are the components of the evaluation vector data λ and are associated with the respective nodes 1 to 4 in the zeroth level (step S21). This evaluation vector data λ is expressed by below equation (21).

λ(0 0 0 0) (21)

The matrix data generation unit 15 calculates the distances dᵢⱼ (i, j=1, 2, 3, 4) between the node i and the node j on the basis of the position coordinates of the nodes in the zeroth level. Further, the matrix data generation unit 15 generates mesh distance data d on the basis of the calculated distances dᵢⱼ (step S22). This mesh distance data d is expressed by equation (22), for example.

$$d = ( \begin{matrix}0 & 1 & 5 & 1 \\ 1 & 0 & 3 & 1 \\ 5 & 3 & 0 & 3 \\ 1 & 1 & 3 & 0\end{matrix} ) \qquad ( 22 )$$

By the way, the coefficient matrix A in the case of FIG. 10 is expressed by equation (23), for example.

$$A = ( \begin{matrix}1 & 0.5 & 0.2 & 0.1 \\ 0.5 & 1 & 0.3 & 0.1 \\ 0.2 & 0.3 & 1 & 0.2 \\ 0.1 & 0.1 & 0.2 & 1\end{matrix} ) \qquad ( 23 )$$

The matrix data generation unit 15 extracts the maximum value 0.5 from among the nonzero elements of the first row of this coefficient matrix A except the diagonal component, and sets 0.5 as a^{max}ᵢ (step S23). Also, the matrix data generation unit 15 extracts the minimum distance 1 from the first row of the mesh distance data d of equation (22) except the diagonal component, and sets 1 as d^{min}₁ (step S24).

The matrix data generation unit 15 calculates the threshold values ε₁ⱼ for the j-th column (j=1, 2, 3, 4) of the mesh distance data d, by applying the minimum distance d^{min}₁(=1) and the mesh distance data d into equation (6). Here, is 0.3 (step S25).

The matrix data generation unit 15 obtains the result expressed by below equation (24), by multiplying a^{max}ᵢ by the threshold value ε₁ᵢ.

aᵢ^{max}*ε₁ⱼ=(0 0.15 3.75 0.15) (24)

The matrix data generation unit 15 determines whether or not each of the nonzero elements a_{1j≠1} (j=2, 3, 4), except the diagonal component, of the first row of the coefficient matrix A expressed by equation (23) satisfies inequality (7) (step S26).

In this case, when the columns (except the first column) of (1 0.5 0.2 0.1) of the first row of the mesh matrix data A are compared with the columns of a^{max}₁*εᵢⱼ respectively, only a₁₂=0.5 of the mesh matrix data A is larger than a^{max}₁*εᵢⱼ.

The matrix data generation unit 15 obtains below equation (25) by adding 1 to the evaluation value λ₂ corresponding to j=2 of the evaluation vector data λ (step S27).

λ(0 1 0 0) (25)

The matrix data generation unit 15 determines that i(=1) is not equal to or larger than the number N(=4) of nodes (step S28), and repeatedly executes steps S23 to S29 with respect to the second to fourth rows (the nodes 2 to 4) of the mesh matrix data A.

The matrix data generation unit 15 repeats this process and obtains the evaluation vector data λ expressed by below equation (26).

λ=(1 1 0 0) (26)

The matrix data generation unit 15 extracts the maximum evaluation value λ₁(=1) from among the evaluation values included in the evaluation vector data λ of equation (26), and sets the extracted maximum evaluation value λ₁ as λ^{max} (step S30).

Note that the evaluation values λ₁ and λ₂ are the maximum value 1 in the evaluation vector data λ of equation (26), and here the evaluation value λ₁ is extracted. The evaluation value λ₂ may be extracted, instead of the evaluation value λ₁.

The matrix data generation unit 15 determines that λ^{max} (the evaluation value λ₁(=1)) is not smaller than 0 (step S31), and sets the node 1 corresponding to the maximum evaluation value λ^{max} as a C point (step S32).

The matrix data generation unit 15 determines that the nonzero elements aⱼ₁ (j=2, 3, 4) of the coefficient matrix A are not 0 (step S33), and sets the nodes 2, 3, and 4 as F points (step S33). Thereby, the nodes 1, 2, 3, and 4 are classified into C points and F points, and the level setting process (n=0) ends.

Thus, in the mesh model 20 of FIG. 10, the simulation apparatus 100 sets the node 1 as a C point, and the nodes 2 to 4 as F points.

As described above, when the level setting process (FIGS. 5 and 6) is performed to the mesh model 20 in consideration of the distances between the nodes, the node 1 is set as a C point, and the nodes 2 to 4 are set as F points. The mesh model 20 is made coarse and leaves the node 1 in the lower level, and the lower level does not include the distorted element of the mesh model 20. When the calculation process (FIG. 8) is performed by using this lower level, the number of iterations is prevented from increasing, and the convergence of the calculation becomes faster.

On the other hand, in a case described below, C points and F points are set in the mesh model 20 by a level setting process (n≥1) (FIGS. 7 and 6) that uses only the coefficient matrix A and does not use the distances between the nodes so as not to remove the distorted element. In this case, when the matrix data generation unit 15 executes the level setting process (n≥1), the evaluation vector data A expressed by equation (27) is obtained.

λ=(2 2 3 1) (27)

In the evaluation vector data λ of equation (27), the evaluation value λ₃ is the maximum, and thus the node 3 is set as a C point. The mesh model 20 is made coarse and leaves the node 3, which makes the element distorted in the mesh model 20 in the lower level. When the calculation process (FIG. 8) is performed by using this lower level, the number of iterations and the calculation time increase.

The above simulation apparatus 100 removes the distorted element of the mesh model by using the distances between the nodes in addition to the mesh matrix data, when making the mesh model coarse. When the iterative calculation is performed by the algebraic multigrid method by using this coarse mesh model, the number of iterations decreases, and the convergence of the calculation becomes faster.

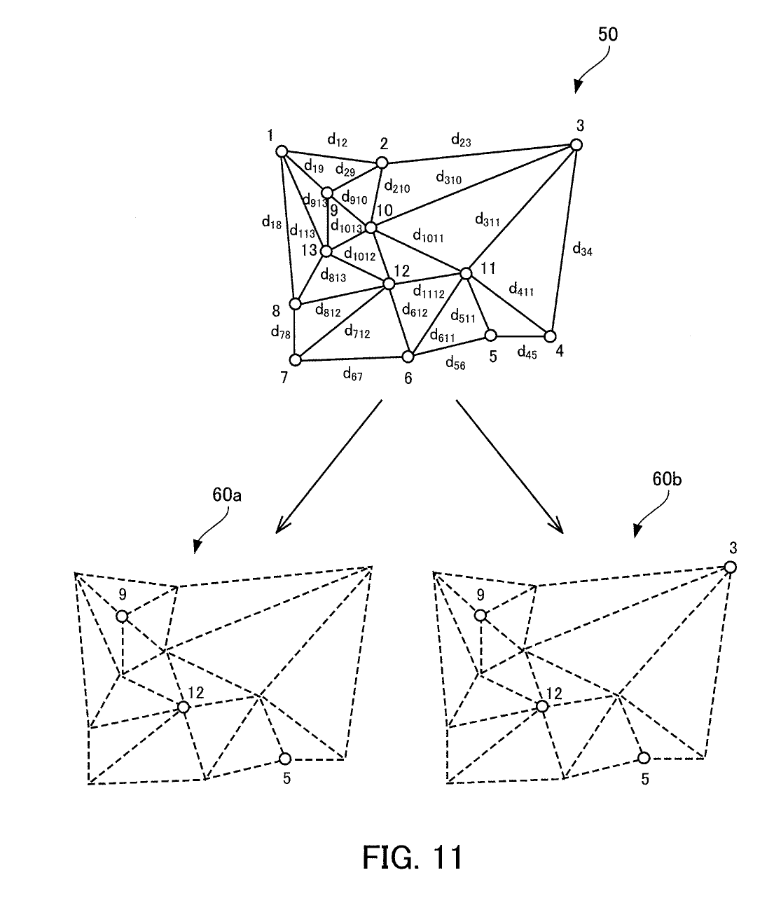

Also, coarse graining in another mesh model will be described with reference to FIG. 11. FIG. 11 illustrates an example of coarse graining of a mesh model.

The mesh model 50 of FIG. 11 incorporates the distances dᵢⱼ from the node i to the node j (i, j(≠i)=1, . . . , n), such as the distance d₁₂ from the node 1 to the node 2 and the distance d₂₃ from the node 2 to the node 3, which are calculated on the basis of the position coordinates of all nodes.

The level setting process (n=0) (FIGS. 5 and 6) described above is executed to the mesh model 50 illustrated in FIG. 11, and a plurality of nodes included in the mesh model 50 are set as C points and F points.

As described above, a mesh model 60a is obtained by making the mesh model 50 coarse. In the mesh model 60a, the nodes 5, 9, and 12 are selected from the nodes of the mesh model 50 and are set as C points, and the other nodes are set as F points. A distorted element having a thin and long shape, a sharp shape, or the like is not included in the nodes 5, 9, and 12 in the mesh model 60a. Thus, when the iterative calculation is performed by the algebraic multigrid method by using the mesh model 60a, the number of iterations decreases, and the calculation speed becomes faster.

On the other hand, a mesh model 60b is obtained from the mesh model 50, by another method for making the mesh model 50 coarse. In the mesh model 60b, the nodes 3, 5, 9, and 12 are selected from the mesh model 50, and the other nodes are excluded. The mesh model 60b differs from the mesh model 60a in that the node 3 is selected, and thus includes a distorted element of a sharp shape. When the solution of a plurality of variables is calculated by using the iterative method on the basis of this mesh model 60b, the number of iterations increases, and the calculation time significantly increases.

Here, static magnetic field calculation by the simulation executed by the simulation apparatus 100 will be described in consideration of the above.

The static magnetic field is a magnetic field generated by temporally stationally magnetization of a magnetic body, and its value is given as a spatial differentiation of the energy of the magnetic field which is called magnetostatic potential. The magnetostatic potential is calculated by equation (28) derived from the Maxwell equation.

Δφ=∇·M (28)

Note that φ is a magnetostatic potential, and M is average magnetization of the magnetic body.

In numerical calculation, the differential equation is discretized, and the magnetostatic potential is calculated as a solution of simultaneous equations in which the nodes of the mesh model are the degree of freedom.

Here, on the basis of a correspondence relationship of equation (28) and equation (1), the coefficient matrix A is calculated from the left side of equation (28), and the right-side vector b is calculated from the right side of equation (28).

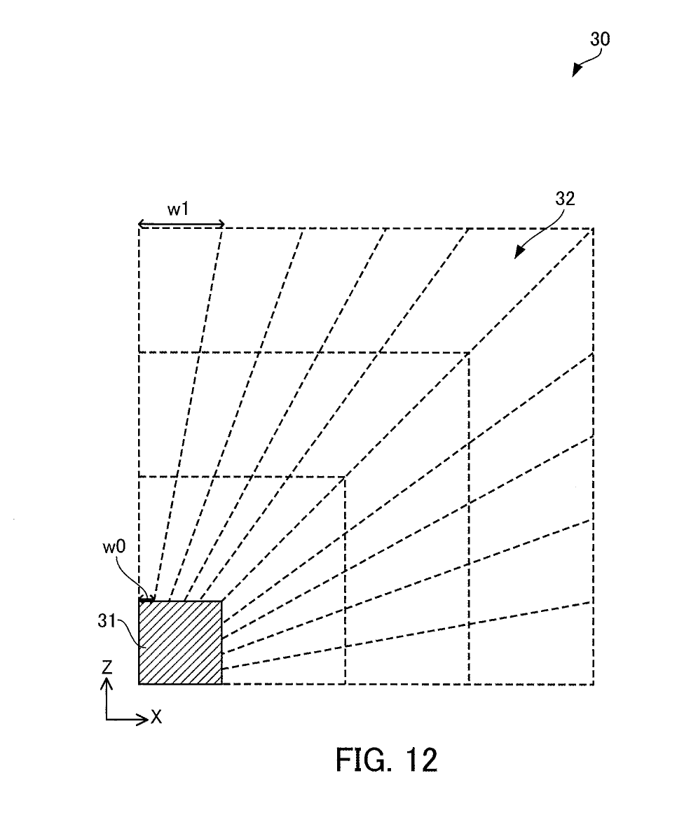

A magnetic body mesh model in this case will be described with reference to FIG. 12. FIG. 12 illustrates an example of a magnetic body mesh model. FIG. 12 illustrates a magnetic body mesh model 30 in an x-z plane in a region of x>0 and z>0.

In the magnetic body mesh model 30, a cubic magnetic body 31, such as a neodymium magnet, is located at the center (origin) of an air region 32, and generates a static magnetic field in the air region 32.

In the magnetic body mesh model 30, the mesh widths (for example, width w0) at the boundary of the air region 32 in contact with the magnetic body 31 are set fine, and the mesh widths (for example, width w1) at the outside boundary are set very coarse. Hence, in the air region 32, the ratio of the maximum edge length to the minimum edge length exceeds 10 so as to form a distorted shape.

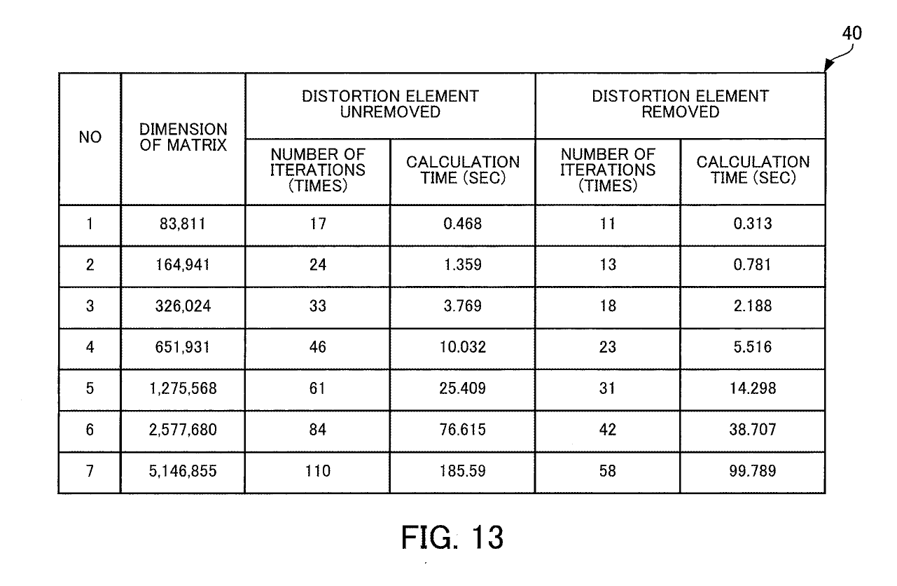

Next, FIG. 13 describes the number of iterations and the calculation time that it takes to obtain a calculation result by solving the simultaneous equation (28) for the magnetic body mesh model 30. FIG. 13 is a table illustrating the number of iterations and the calculation time that it takes to calculate a magnetostatic potential.

The number of elements in the magnetic body mesh model 30 is set within a range from 80,000 to 5,200,000, in order to measure the number of iterations and the calculation time that it takes to solve the simultaneous equation (28).

The table 40 includes the measurement results obtained when the distorted elements of the mesh are not removed (distorted element unremoved) during the coarse graining of the magnetic body mesh model 30 for solving the simultaneous equation (28). Also, the table 40 includes the measurement results obtained when the distorted elements of the mesh are removed (distorted element removed) by utilizing the distances between the nodes in addition to the mesh matrix data, during the coarse graining of the magnetic body mesh model 30 for solving the simultaneous equation (28).

In this table 40, in each dimension (the number of elements) of the matrix, the number of iterations decreases by approximately 35% to 50% when the distorted elements are removed than when the distorted elements are not removed. Along with this, the calculation time also decreases by approximately 33% to 50%. In particular, as the dimension of the matrix is larger, the number of iterations and the calculation time are improved more.

The above processing functions are implemented by a computer. In that case, there is provided a program that describes the procedures of the functions that the computer is to have. By executing the program in the computer, the above processing functions are implemented in the computer.

The program describing the procedures may be stored in a computer-readable storage medium. The computer-readable storage medium is a magnetic memory device, an optical disc, a magneto optical memory medium, a semiconductor memory, or the like. The magnetic memory device is an HDD, a flexible disk (FD), a magnetic tape (MT), or the like. The optical disc is a DVD, a DVD-RAM, a CD-ROM, a CD-R(Recordable)/RW(ReWritable), or the like. The magneto optical memory medium is an MO or the like. The semiconductor memory is, for example, a flash memory, such as a universal serial bus (USB) memory.

In order to put the above program in market, a portable storage medium, such as a DVD and a CD-ROM, storing the program is sold, for example. Also, the program may be stored in a server computer and be transferred from the server computer to another computer via a network.

In order to execute the above program, the computer reads the program recorded in a portable storage medium or receives the program transferred from a server computer, and stores the program in a memory device of the computer, for example. Then, the computer reads the program from the memory device of the computer and performs processing in accordance with the program. Note that the computer may read the program directly from a portable storage medium and perform processing in accordance with the program. Also, the computer may perform processing sequentially in accordance with a received program, each time the program is transferred from a server computer.

Also, a part or all of the processes described by the program may be replaced by an electronic circuit. For example, at least a part of the above processing function may be implemented by an electronic circuit, such as a DSP, an ASIC, and a programmable logic device (PLD).

In one aspect, convergence of calculation by an iterative method is sped up.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a computer program that causes a computer to perform a procedure comprising:
acquiring first matrix data including coefficient values indicating attributes between a plurality of nodes in a first mesh model;
generating distance data indicating distances between the plurality of nodes, based on position coordinates of the plurality of nodes in the first mesh model;
calculating a threshold value based on a distance indicated by the distance data corresponding to each of a plurality of pairs of the nodes in the first mesh model;
comparing the threshold value with a coefficient value corresponding to the each pair of the nodes in the first matrix data;
updating at least some of a plurality of evaluation values respectively corresponding to the plurality of nodes, based on a result of the comparing;
generating second matrix data of a second mesh model created by selecting some of the plurality of nodes, based on the plurality of evaluation values and excluding the selected some nodes from the first mesh model; and
calculating a solution of a plurality of variables associated with the plurality of nodes, by using the first matrix data and the second matrix data.

2. The non-transitory computer-readable storage medium according to claim 1, wherein
the threshold value is calculated larger as the distance between the each pair of nodes is larger, and
the updating includes increasing an evaluation value corresponding to one of a pair of nodes, when a coefficient value corresponding to the pair of nodes is larger than the threshold value.

3. The non-transitory computer-readable storage medium according to claim 1, wherein
the pairs of nodes include a pair of a first node and a second node, and
the calculating of the threshold value includes identifying a minimum distance from among distances between the first node and two or more nodes including the second node, and calculating the threshold value, based on a distance between the first node and the second node and the minimum distance.

4. A simulation method comprising:
acquiring, by a processor, first matrix data including coefficient values indicating attributes between a plurality of nodes in a first mesh model;
generating, by the processor, distance data indicating distances between the plurality of nodes, based on position coordinates of the plurality of nodes in the first mesh model;
calculating, by the processor, a threshold value based on a distance indicated by the distance data corresponding to each of a plurality of pairs of the nodes in the first mesh model, comparing the threshold value with a coefficient value corresponding to the each pair of the nodes in the first matrix data, and updating at least some of a plurality of evaluation values respectively corresponding to the plurality of nodes, based on a result of the comparing;
generating, by the processor, second matrix data of a second mesh model created by selecting some of the plurality of nodes, based on the plurality of evaluation values and excluding the selected some nodes from the first mesh model; and
calculating, by the processor, a solution of a plurality of variables associated with the plurality of nodes, by using the first matrix data and the second matrix data.

5. An information processing apparatus comprising:
a memory configured to store first matrix data including coefficient values indicating attributes between a plurality of nodes in a first mesh model; and
a processor configured to perform a procedure including:
generating distance data indicating distances between the plurality of nodes, based on position coordinates of the plurality of nodes in the first mesh model,
calculating a threshold value based on a distance indicated by the distance data corresponding to each of a plurality of pairs of the nodes in the first mesh model,
comparing the threshold value with a coefficient value corresponding to the each pair of the nodes in the first matrix data,
updating at least some of a plurality of evaluation values respectively corresponding to the plurality of nodes, based on a result of the comparing,
generating second matrix data of a second mesh model created by selecting some of the plurality of nodes, based on the plurality of evaluation values and excluding the selected some nodes from the first mesh model, and
calculating a solution of a plurality of variables associated with the plurality of nodes, by using the first matrix data and the second matrix data.
